(19) United States
(12) Patent Application Publication
(10) Pub. No.: US 2026/0189989 A1
(43) Pub. Date: Jul. 2, 2026

(54) COMMUNICATION CONTROL METHOD, BASE STATION, AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/551,809

(22) Filed: Feb. 27, 2026

Related U.S. Application Data
(63) Continuation of application No. PCT/JP2024/030763, filed on Aug. 28, 2024.

(30) Foreign Application Priority Data
Aug. 30, 2023 (JP) 2023-140371

(51) Int. Cl. H04W 36/00; H04L 41/16; H04W 36/32

(52) U.S. Cl. CPC H04W 36/0016; H04L 41/16; H04W 36/324

(57) ABSTRACT

A communication control method according to an aspect is a communication control method in a mobile communication system. The communication control method includes dividing, by a network node, a trained AI/ML model into a first divided trained model and a second divided trained model. The communication control method includes transmitting, by the network node, a first message including the first divided trained model to a user equipment. The communication control method includes acquiring, by the user equipment, position information indicating a position of the user equipment. The communication control method includes acquiring, by the user equipment, output result data from the position information by using the first divided trained model. The communication control method includes transmitting, by the user equipment, a second message including the output result data to the network node.

### RELATED APPLICATIONS

The present application is a continuation based on PCT Application No. PCT/JP2024/030763, filed on Aug. 28, 2024, which claims the benefit of Japanese Patent Application No. 2023-140371 filed on Aug. 30, 2023. The content of which is incorporated by reference herein in their entirety.

### TECHNICAL FIELD

The present disclosure relates to a communication control method, a base station, and user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: RP-213599, “New SI: Study on Artificial Intelligence (AI)/Machine Learning (ML) for NR Air Interface”

Non-Patent Document 2: RWS-230240, “Motivations on AI/ML-based mobility enhancement”

### SUMMARY

A communication control method according to a first aspect is a communication control method in a mobile communication system. The communication control method includes dividing, by a network node, a trained AI/ML model into a first divided trained model and a second divided trained model. The communication control method includes transmitting, by the network node, a first message including the first divided trained model to a user equipment. The communication control method includes acquiring, by the user equipment, position information indicating a position of the user equipment. The communication control method includes acquiring, by the user equipment, output result data from the position information by using the first divided trained model. The communication control method includes transmitting, by the user equipment, a second message including the output result data to the network node. The communication control method includes inferring, by the network node, whether to execute a mobility operation from the output result data by using the second divided trained model. Here, the mobility operation includes at least transmitting a handover request message to another network node by the network node.

A network node according to a second aspect is a network node in a mobile communication system. The network node includes a controller configured to divide a trained AI/ML model into a first divided trained model and a second divided trained model. The network node also includes a transmitter configured to transmit a first message including the first divided trained model to user equipment. The network node further includes a receiver configured to receive, from the user equipment, a second message including output result data acquired from position information by the user equipment by using the first divided trained model. The controller infers whether to execute a mobility operation from the output result data by using the second divided trained model. The mobility operation includes at least transmitting a handover request message to another network node by the network node.

A user equipment according to a third aspect is user equipment in a mobile communication system. The user equipment includes a receiver configured to receive a first message including a first divided trained model from a network node, the first divided trained model being obtained by dividing a trained AI/ML model into the first divided trained model and a second divided trained model. The user equipment includes a controller configured to acquire position information indicating a position of the user equipment and acquire output result data from the position information by using the first divided trained model. The user equipment further includes a transmitter configured to transmit a second message including the output result data to the network node. The network node infers whether to execute a mobility operation from the output result data by using the second divided trained model. The mobility operation includes at least transmitting a handover request message to another network node by the network node.

### BRIEF DESCRIPTION OF THE DRAWINGS

FIG. 1 is a diagram illustrating a configuration example of a mobile communication system according to a first embodiment.

FIG. 2 is a diagram illustrating a configuration example of user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an arrangement example of functional blocks of the AI/ML technology according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an operation example according to the first embodiment.

FIG. 14 is a diagram illustrating an example of a configuration message according to the first embodiment.

FIG. 15 is a diagram illustrating a configuration example of functional blocks of the AI/ML technology according to the first embodiment.

FIG. 16 is a diagram illustrating an example of a trained model according to the first embodiment.

FIG. 17 is a diagram illustrating an example of the trained model according to the first embodiment.

FIG. 18 is a diagram illustrating an operation example according to the first embodiment.

FIG. 19 is a diagram illustrating an example of the trained model according to the first embodiment.

FIG. 20 is a diagram illustrating an example of the trained model according to the first embodiment.

### DESCRIPTION OF EMBODIMENTS

An object of the present disclosure is to efficiently use a trained AI/ML model while ensuring the confidentiality of inference result data inferred from the trained AI/ML model. Another object of the present disclosure is to reduce a load on the trained model.

### First Embodiment

A mobile communication system according to a first embodiment will be described with reference to the drawings. In the description of the drawings, the same or similar parts are denoted by the same or similar reference signs.

### Configuration of Mobile Communication System

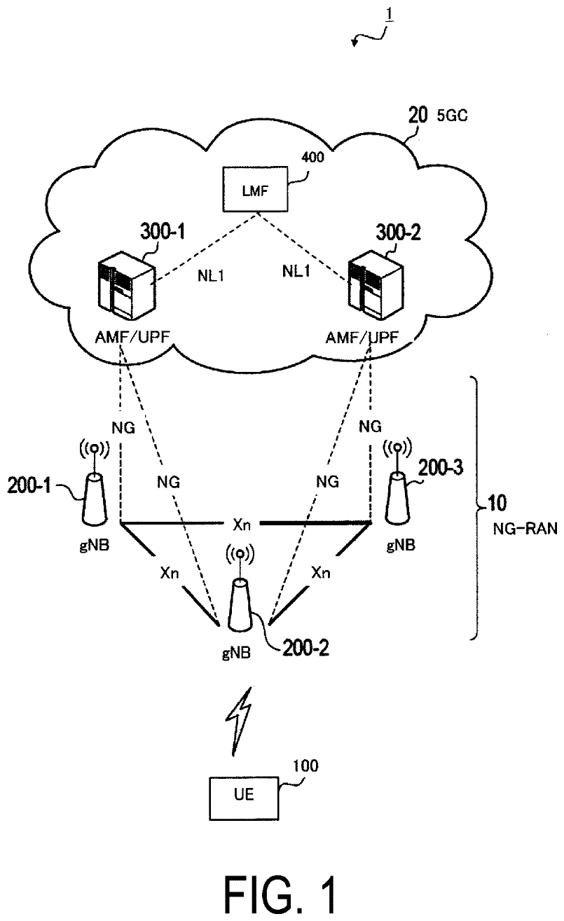

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

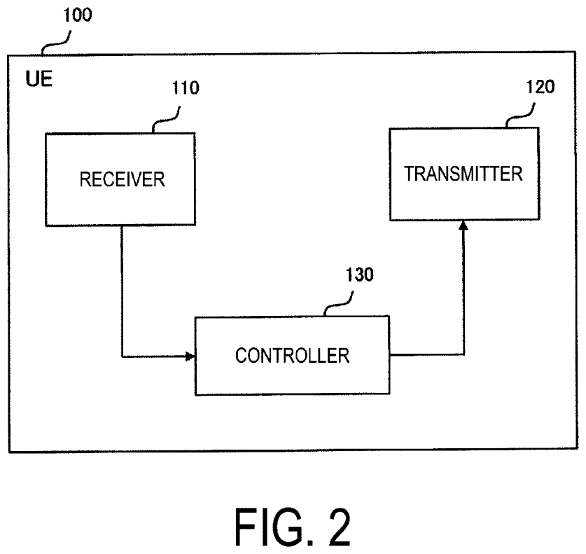

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

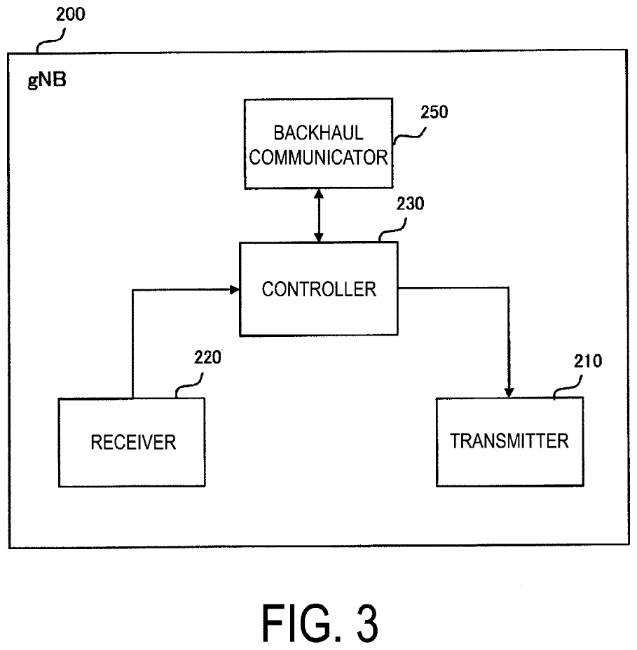

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

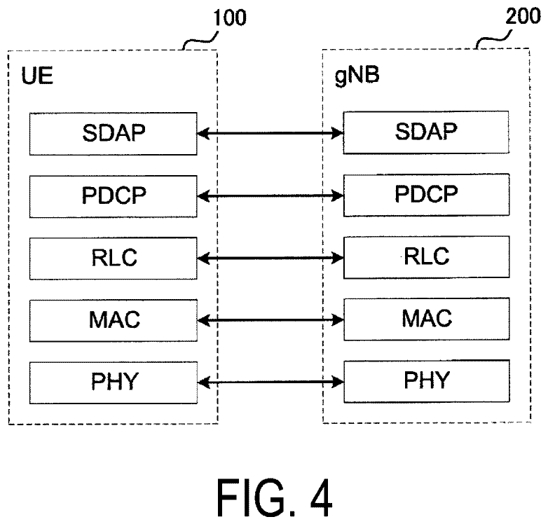

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

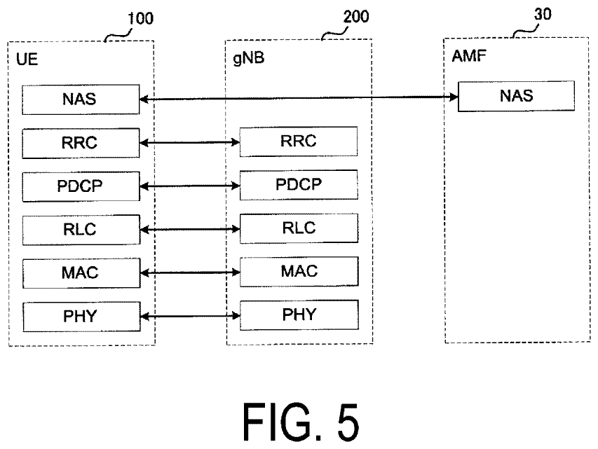

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is at a higher position than the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

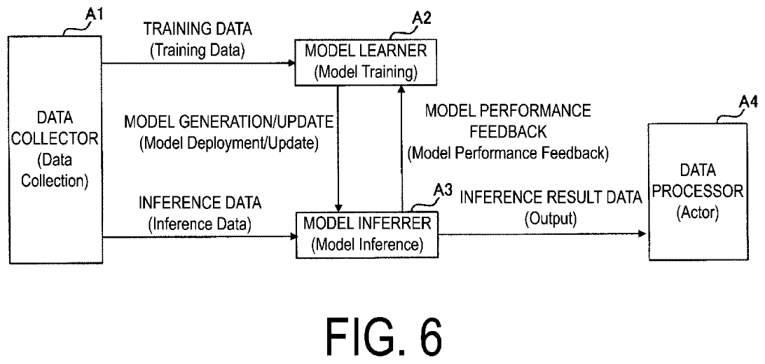

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model learner A2, a model inferrer A3, and a data processor A4.

The data collector A1 collects input data, specifically, training data and inference data. The data collector A1 outputs the training data to the model learner A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model learner A2 performs model training. Specifically, the model learner A2 optimizes parameters of the training model through machine learning using the training data, and derives (or generates, or updates) the trained model. The model learner A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning. In this way, the process of training an AI/ML model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model learner A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

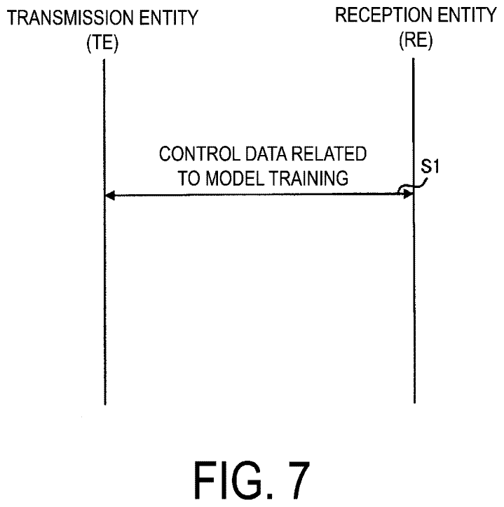

FIG. 7 is a diagram illustrating an operation example in the AI/ML technology according to the first embodiment.

A transmission entity TE is, for example, an entity in which machine learning is performed. The transmission entity TE may derive a trained model by performing machine learning. The transmission entity TE uses the trained model to generate inference result data as an inference result. The transmission entity TE can transmit the inference result data to a reception entity RE.

On the other hand, the reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

An entity may be, for example, an apparatus, may be a functional block included in an apparatus, or may be a hardware block included in an apparatus.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

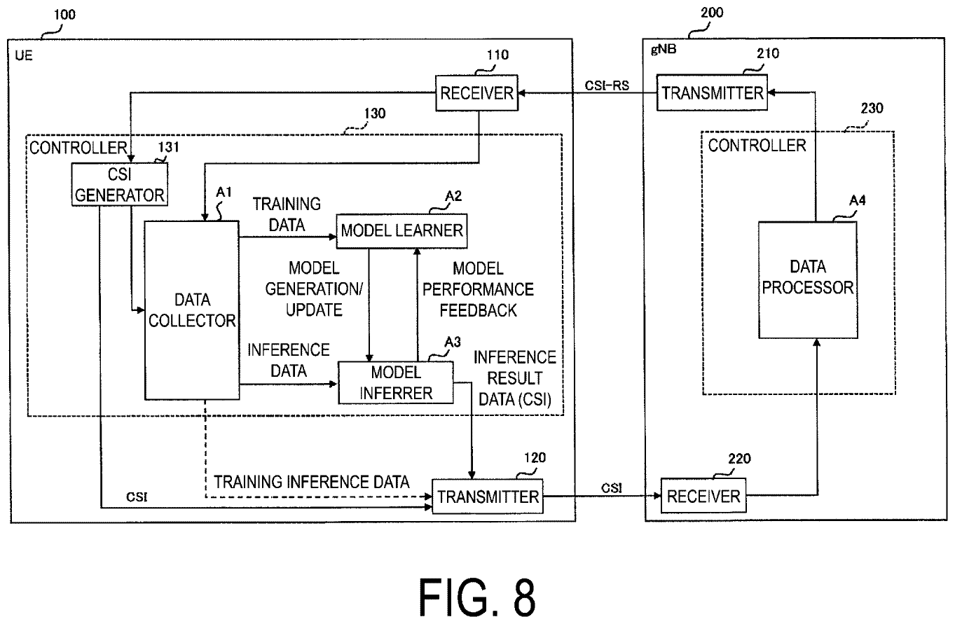

As illustrated in FIG. 8, in step S1, the transmission entity TE transmits control data regarding the AI/ML technology to the reception entity RE and receives the control data from the reception entity RE. The control data may be an RRC message that is RRC layer (i.e., layer 3) signaling. The control data may be a MAC Control Element (CE) that is MAC layer (i.e., layer 2) signaling. The control data may be downlink control information (DCI) that is PHY layer (that is, layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”

Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model learner A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model learner A2) derives a trained model for inferring CSI from the reference signal by using training data including the first reference signal and CSI. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model learner A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

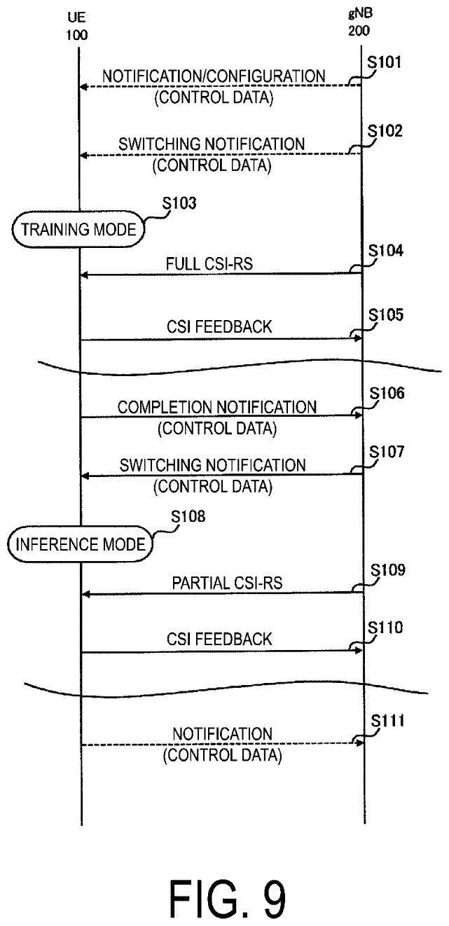

FIG. 9 is a diagram illustrating an operation example in the “CSI feedback enhancement according to the first embodiment.

As illustrated in FIG. 9, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model learner A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 9, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) moving speed of the UE 100 (which may be measured by a speed sensor in the UE 100)

What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

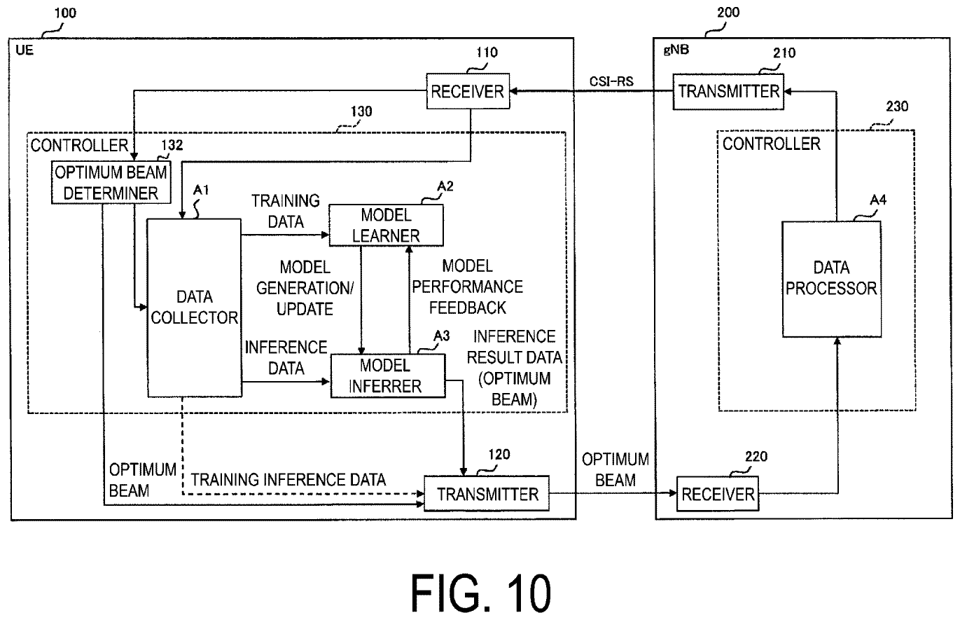

FIG. 10 is a diagram illustrating an arrangement example of the functional blocks in the “beam management”. In the example of the “beam management” illustrated in FIG. 10, the controller 130 of the UE 100 includes the data collector A1, the model learner A2, and the model inferrer A3. On the other hand, the controller 230 of the gNB 200 includes the data processor A4. In other words, FIG. 10 illustrates an example in which the UE 100 performs model training and model inference. FIG. 10 illustrates the example in which the transmission entity TE is the UE 100 and the reception entity RE is the gNB 200.

As illustrated in FIG. 10, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 9.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model learner A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6), or may include, aside from the training data and the inference data, any information or data from among (Y1) to (Y6). The gNB 200 may transmit, to the UE 100 as the control data, the data type information used as a dataset. The data type information may include any information or data from among (Y1) to (Y6), or may include, aside from the training data and the inference data, the data type information may include any information or data from among (Y1) to (Y6), for example.

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

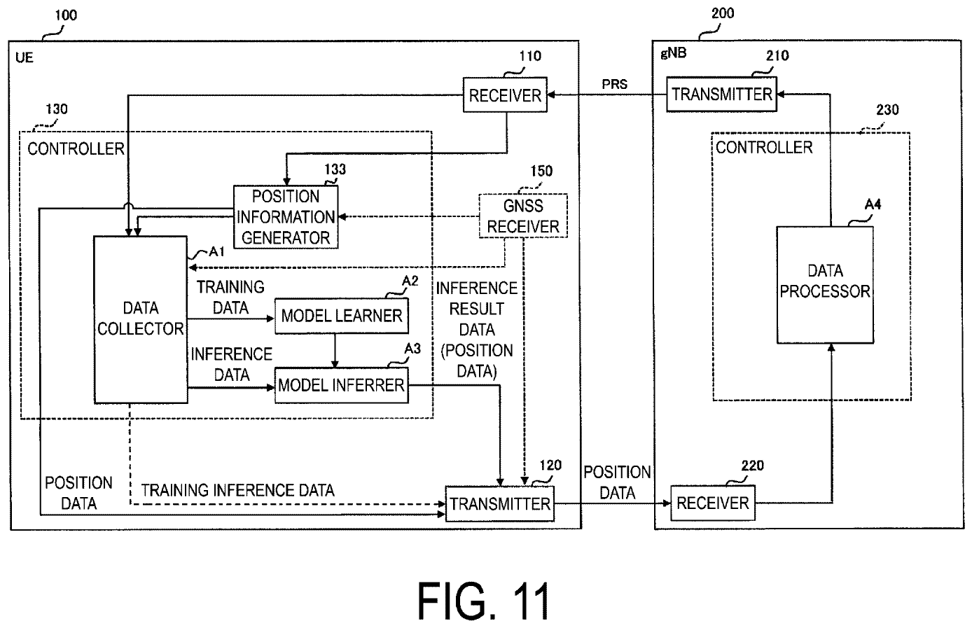

FIG. 11 is a diagram illustrating an arrangement example of the functional blocks in the “positioning accuracy enhancement”. In the example of the “positioning accuracy enhancement” illustrated in FIG. 11, the controller 130 of the UE 100 includes the data collector A1, the model learner A2, and the model inferrer A3. On the other hand, the controller 230 of the gNB 200 includes the data processor A4. In other words, FIG. 11 illustrates an example in which the UE 100 performs model training and model inference. FIG. 11 illustrates an example in which the transmission entity TE is the UE 100 and the reception entity RE is the gNB 200.

As illustrated in FIG. 11, the UE 100 includes a position information generator 133. The UE 100 may include a Global Navigation Satellite System (GNSS) reception device 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports or a predetermined amount of time frequency resources). As with the partial CSI-RS, the gNB 200 transmits the partial PRS by using the second resources (for example, half the antenna ports in the antenna panel or half the predetermined amount of time-frequency resources) having the smaller amount of resources than the first resources.

The full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 9.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model learner A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS reception device 150. The moving speed may be measured by a speed sensor in the UE 100)

The UE 100 may transmit capability information as the control data to the gNB 200, the capability information indicating which type of input data the UE 100 can handle in the machine learning. The capability information may include any of the information or data (Z1) to (Z7), or may include any of the information or data (Z1) to (Z7) separately from the training data and the inference data. The gNB 200 may transmit, to the UE 100 as the control data, the data type information used as a dataset. The data type information may include, for example, any one of the pieces of data or information indicated by (Z1) to (Z7), or may include any one of the pieces of information or data indicated by (Z1) to (Z7) apart from the training data and the inference data.

### (1.4) Other Arrangement Examples

Other arrangement examples will be described next.

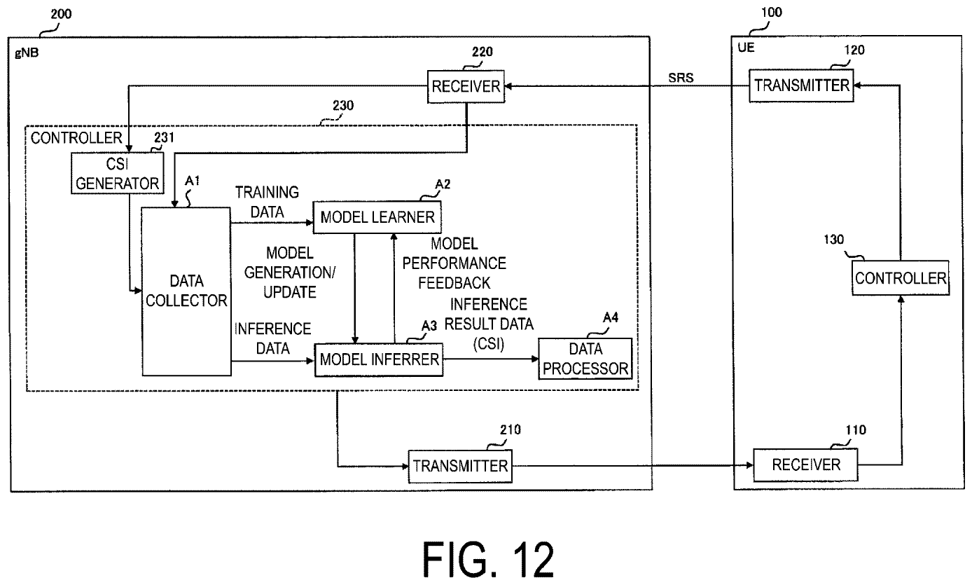

FIG. 12 is a diagram illustrating another arrangement example of the “CSI feedback enhancement” according to the first embodiment. FIG. 12 illustrates an example in which the gNB 200 includes the data collector A1, the model learner A2, the model inferrer A3, and the data processor A4. In other words, FIG. 12 illustrates an example in which the gNB 200 performs model training and model inference. FIG. 12 illustrates an example in which the transmission entity TE is the gNB 200 and the reception entity RE is the UE 100.

FIG. 12 illustrates an example in which the AI/ML technology is introduced into CSI estimation performed by the gNB 200 based on a sounding reference signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Relating to Model Transfer

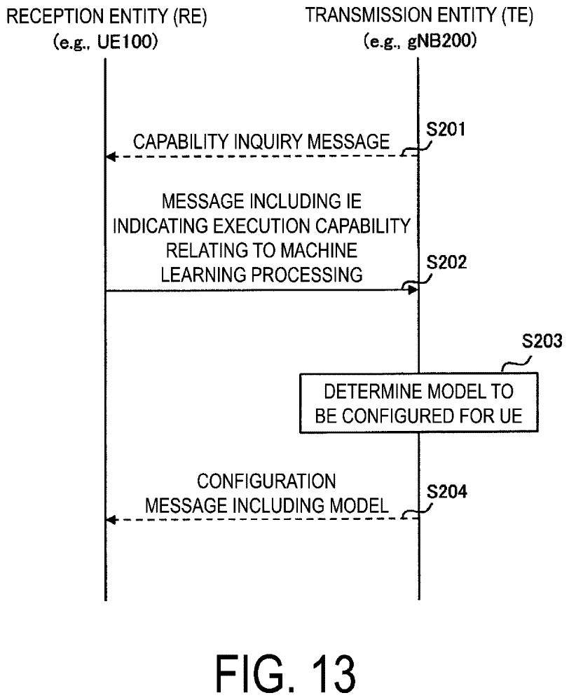

FIG. 13 is a diagram illustrating an operation example of a first operation pattern relating to model transfer according to the first embodiment. In the example illustrated in FIG. 13, the reception entity RE is mainly described as the UE 100. However, the reception entity RE may be the gNB 200 or AMF 300. In the example illustrated in FIG. 13, the transmission entity TE is mainly described as the gNB 200. However, the transmission entity TE may be the UE 100 or AMF 300.

As illustrated in FIG. 13, in step S201, the gNB 200 transmits, to the UE 100, a capability inquiry message for requesting transmission of a message including an information element (IE) indicating execution capability relating to machine learning processing. The UE 100 receives the capability inquiry message. However, the gNB 200 may transmit the capability inquiry message when performing the machine learning processing (when determining to perform the machine learning process).

In step S202, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported, or may be an information element indicating a period of time (or a response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing or an information element indicating the processing capacity of the learning processing.

In step S203, the gNB 200 determines a model to be configured (deployed) for the UE 100 based on the information element included in the message received in step S202.

In step S204, the gNB 200 transmits, to the UE 100, a message including the model determined in step S203. The UE 100 receives the message and performs the machine learning processing (that is, model training processing and/or model inference processing) using the model included in the message. A specific example of step S204 will be described in a second operation pattern below.

### (1.5.2) Second Operation Pattern Relating to Model Transfer

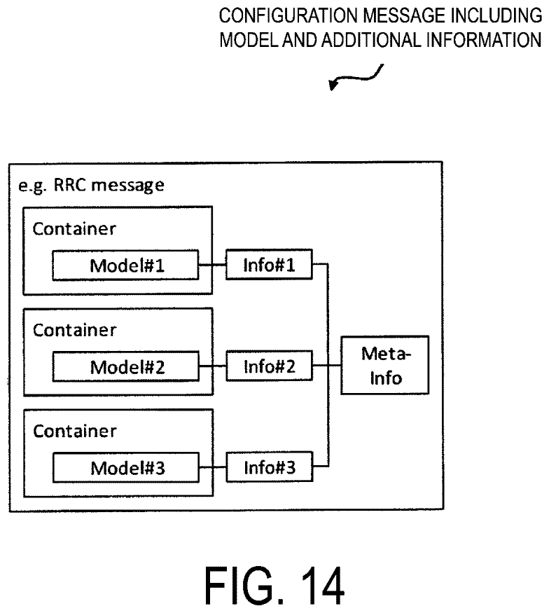

FIG. 14 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 14, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like), or may be a model selection criterion that applies (executes) a corresponding model depending on whether the designated criterion (for example, a moving speed) is satisfied.

### (1.6) Configuration Example of Functional Blocks

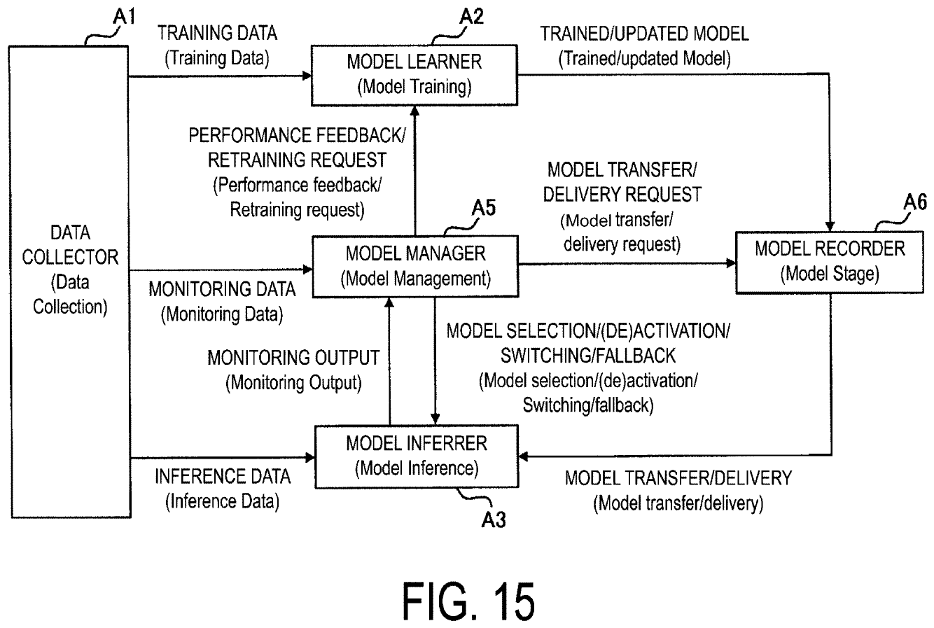

The functional blocks for AI for wireless communication have been described with reference to FIG. 6. Currently, in 3GPP, a block diagram illustrated in FIG. 15 is being studied for functional blocks of AI for wireless communication.

FIG. 15 is a diagram illustrating a configuration example of functional blocks according to the first embodiment. The functional block diagram illustrated in FIG. 15 further includes a model manager A5 and a model recorder A6, as compared with the functional block diagram illustrated in FIG. 6.

The model manager A5 manages an AI/ML model. For example, the model manager A5 requests the model learner A2 to relearn a training model, or requests the model recorder A6 to perform model transfer. As illustrated in FIG. 15, the AI/ML model that has been trained by retraining may be referred to as an updated model. For example, the model manager A5 instructs (or requests) the model inferrer A3 to perform model selection, model (de)activation, model switching, and/or fallback. The model manager A5 may evaluate the performances of trained models using the monitoring data acquired from the data collector A1 and the monitoring output acquired from the model inferrer A3, and request retraining or instruct model switching based on evaluation results.

The model recorder A6 functions as a reference point in the functional block. For this reason, the model recorder A6 does not necessarily have to record a trained model or an updated model in a recording medium.

Note that how the functional blocks illustrated in FIG. 15 are disposed in each use case is in a study stage in 3GPP.

In the following, an AI/ML model to be trained may be referred to as a “training model and a trained AI/ML model may be referred to as a “trained model”. Data for inference may be referred to as inference data, and data for training may be referred to as training data.

### Communication Control Method According to First Embodiment

A communication control method according to the first embodiment will be described.

As described in the use case of “positioning accuracy enhancement”, position information may be used in the AI/ML model. However, there may be a concern about position information used in the AI/ML model from the viewpoint of privacy. In 3GPP, it has been pointed out that there exists a concern about privacy of the UE 100 regarding the position information (for example, Non-Patent Document 2: RWS-230240).

For example, when the UE 100 satisfies an event condition (event A1, event A2, and the like) of a handover, the UE transmits a measurement report (MeasurementReport) to a serving cell. When the serving cell determines to perform the handover in the UE 100, the serving cell transmits a handover request (HANDOVER REQUEST) message to a target cell. When the target cell determines to accept the handover, the target cell transmits a handover request acknowledge (HANDOVER REQUEST ACKNOWLEDGE) message including information for accessing the target cell to the serving cell. The serving cell transmits a message (for example, an RRC reconfiguration (RRCReconfiguration) message) including the information to the UE 100. This enables the UE 100 to execute a handover from the serving cell to the target cell.

However, the measurement report may include position information (Locationinfo) of the UE 100.

Some users who use the UE 100 may not desire to use position information from the viewpoint of privacy. For example, a user A may not desire to include and transmit position information of the user A's residence in a measurement report. On the other hand, a network side may desire to efficiently perform a handover procedure by using the measurement report including the position information of the UE 100.

It is also conceivable that the gNB 200 transmits a trained model to the UE 100. That is, the trained model is an AI/ML model in which position information is used as inference data, and whether a serving cell (or a serving gNB) has transmitted a handover request message to a target cell (or a target gNB) is used as inference result data. When the UE 100 inputs its own position information to the trained model and obtains, from the trained model, information indicating whether the handover request message has been transmitted, the UE 100 transmits a message including the information to the gNB 200. The gNB 200 can determine the transmission of the handover request message to the target cell, based on the information. This enables the gNB 200 to transmit the handover request message to the target cell without the UE 100 transmitting the measurement report including the position information to the gNB 200.

However, the network side transmits the trained model to the UE 100, and thus the UE 100 may be notified of information to be concealed. For example, information indicating the occurrence of a ping-pong phenomenon in which a handover to a target cell is repeated a plurality of times within a certain period of time at a certain specific location even though a coverage in a source cell is sufficient may be information to be concealed by an operator (or a communication carrier). When the UE 100 obtains inference result data indicating that handover request messages are transmitted at a plurality of locations in close proximity, the information may imply the occurrence of the ping-pong phenomenon. There exists a concern that the UE 100 will transmit the information to (a base station or an access point of) another operator. In this manner, the inference result data obtained from the trained model in the UE 100 may be information to be concealed.

When the gNB 200 transmits a trained model having a certain amount or more of information to the UE 100, storing and using the trained model may become a burden on the UE 100.

An object of the first embodiment is to make it possible to efficiently use a trained AI/ML model while ensuring the confidentiality of inference result data inferred from the trained AI/ML model. Another object of the first embodiment is to reduce a load on a trained model.

For this reason, in the first embodiment, first, a base station (for example, the gNB 200) divides a trained AI/ML model into a first divided trained model and a second divided trained model. Second, the base station transmits a first message including the first divided trained model to user equipment (for example, the UE 100). Third, the user equipment acquires position information indicating the position of the user equipment. Fourth, the user equipment acquires output result data from the position information by using the first divided trained model. Fifth, the user equipment transmits a second message including the output result data to the base station. Sixth, the base station infers whether to execute a mobility operation from the output result data by using the second divided trained model. Here, the mobility operation includes at least transmission of a handover request message from the base station to another base station.

In this manner, in the first embodiment, a trained model is divided, and the trained model is executed by being distributed to the UE 100 and the gNB 200. The gNB 200 can acquire inference result data by the trained model. Thereby, for example, the gNB 200 can perform inference without the UE 100 inferring information indicating whether the gNB 200 transmits a handover request message to another base station, thus allowing a trained AI/ML model to be efficiently used while ensuring the confidentiality of the inference result data.

In the first embodiment, the entire trained model is not transmitted to the UE 100, and the first divided trained model obtained by dividing the trained model is transmitted to the UE 100. Thus, in the first embodiment, it is also possible to reduce a load on the UE 100 as compared with a case where the entire trained model is transmitted to the UE 100.

### Example of Division of Trained Model According to First Embodiment

An example of division of a trained model according to the first embodiment will be described.

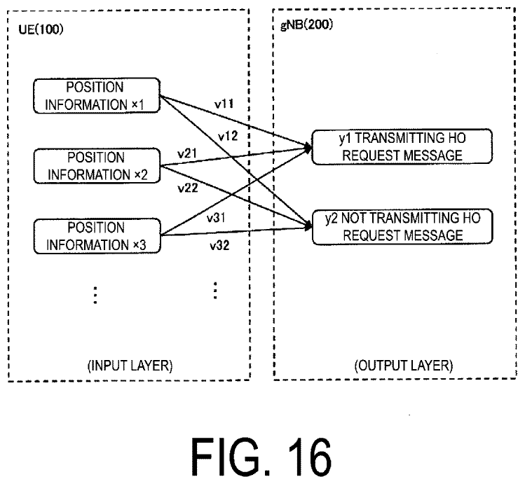

FIG. 16 is a diagram illustrating an example of division of a trained model according to the first embodiment.

FIG. 16 illustrates an example of a trained model that does not include an intermediate layer (or hidden layer) and is configured with an input layer and an output layer. Such a trained model may be referred to as a single-layer model (or a single-layer perceptron). The trained model illustrated in FIG. 16 represents an example of a model that uses position information as inference data and infers inference result data indicating whether the gNB 200 transmits a handover request message to a target gNB (or a target cell). The transmission of the handover request message by the gNB 200 to another gNB is an example of a mobility operation.

As illustrated in FIG. 16, one trained model is executed by being distributed to the UE 100 and the gNB 200. The gNB 200 may divide the trained model. The divided trained model including at least the input layer may be referred to as a first divided trained model. The divided trained model including at least the output layer may be referred to as a second divided trained model.

After dividing the trained model, the gNB 200 transmits the first divided trained model to the UE 100. Specifically, the gNB 200 transmits, as the first divided trained model, position information x1, a weighting v11 to y1 (transmitting a handover request message) for the position information x1, and a weighting v12 to y2 (not transmitting a handover request message) for the position information x1. The gNB 200 transmits, as the first divided trained model, position information x2, a weighting v21 to y1 for the position information x2, and a weighting v22 to y2 for the position information x2. In this manner, the gNB 200 transmits, as the first divided trained model, each piece of position information included in the trained model, a weighting of y1 for the position information, and a weighting of y2 for the position information.

Note that the gNB 200 may be transmitted in a list of weightings in order to conceal y1 and y2. For example, a weighting list “v11 v12” may be transmitted. In this case, the first entry represents a weighting of y1, and the last entry represents a weighting of y2. Alternatively, the gNB 200 may simply transmit a list “y1 v11 y2 v12”. In this case, the weighting of y1 represents v11, and the weighting of y2 represents v12. However, the notation that y1 is “transmitting a handover request message” and the notation that y2 is “not transmitting a handover request message” are not included in the entry (or the first divided trained model transmitted to the UE 100).

After receiving the first divided trained model, the UE 100 performs processing corresponding to the input layer using the first divided trained model.

That is, the UE 100 acquires position information using the GNSS reception device 150 or a PRS. The UE 100 obtains output result data corresponding to the position information by using the first divided trained model. For example, the UE 100 may obtain the output result data as follows.

That is, it is assumed that the position information acquired by the UE 100 is x1. In this case, the UE acquires, based on the model, the weighting v11 to y1 (that is, transmitting the handover request message) from the position information x1 and the weighting v12 to y2 (that is, not transmitting the handover request message) from the acquired position information x1 by using the first divided trained model. The UE 100 transmits the weighting v11 and the weighting v12 to the gNB 200. The UE 100 may transmit the weighting list “v11 v12” to the gNB 200. In this case, the first entry of the weighting list represents the weighting of y1 (transmitting the handover request message), and the last entry represents the weighting of y2 (not transmitting the handover request message). The weighting list may represent an output result (that is, output result data) of the first divided trained model. When the UE 100 obtains output result data corresponding to the position information using the first divided trained model, the UE 100 transmits the output result data to the gNB 200.

After receiving the output result data, the gNB 200 performs processing corresponding to the output layer using the second divided trained model. For example, the gNB 200 may perform the following processing.

That is, the gNB 200 receives the weighting list as the output result data, and ascertains the weighting v11 to y1 (transmitting the handover request message) and the weighting v12 to y2 (not transmitting the handover request message) as the processing in the output layer. The gNB 200 may compare the two weightings v11 and v12 and perform processing of a larger one (y1 or y2).

Note that the weighting may be rephrased as probability. For example, in FIG. 16, the probability of the position information x1 to y1 is v11, and the probability of the position information x1 to y2 is v12.

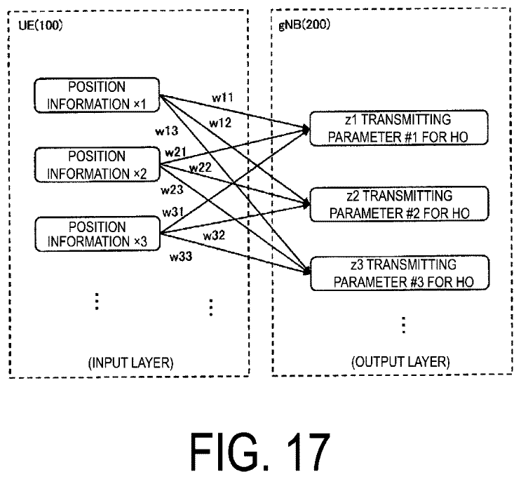

FIG. 17 is a diagram illustrating an example of division of the trained model according to the first embodiment. The example illustrated in FIG. 17 also represents an example of a single-layer model.

The trained model used in FIG. 17 is a model that obtains inference result data indicating that the gNB 200 transmits a handover parameter (according to position information) to the UE 100, using the position information as inference data. The setting (or transmission) of the handover parameter used for the handover is an example of a mobility operation.

In the case of the trained model illustrated in FIG. 17, the trained model is also executed by being distributed to the UE 100 and the gNB 200. For this reason, the gNB 200 transmits the first divided trained model to the UE 100. Specifically, the gNB 200 transmits a probability w11 of z1 (transmitting a handover parameter #1) for the position information x1, a probability w12 of z2 (transmitting a handover parameter #2) for the position information x1, a probability w13 of z3 (transmitting a handover parameter #3) for the position information x1. For example, the gNB 200 may transmit a list of probabilities (for example, “x1 w11 w12 w13 . . . ” for the position information as the first divided trained model. In this case, the probability of z1, the probability of z2, the probability of z3, . . . may be represented in the order of “w11 w12 w13 . . . ”. The gNB 200 may list z1, z2, . . . (for example, “x1 z1 w11 z2 w12 z3 w13 . . . ”) as a first trained model. In this case, it is represented that the probability of z1 from the position information x1 is w11, the probability of z2 from the position information x1 is w12, and . . .

After acquiring the position information, the UE 100 obtains probabilities (for example, the probability w11, the probability w12, the probability w13, . . . ) for position information (for example, the position information x1) by using the first divided trained model. The UE 100 transmits the probabilities to the gNB 200 as output result data. The UE 100 may list the probabilities (“w11 w12 w13 . . . ”) and transmit the listed probabilities. The gNB 200 can perform processing on the second divided trained model by ascertaining that the first probability w11 in the list is the probability of z1, the next probability w12 is the probability of z2, and the like.

### Operation Example According to First Embodiment

An operation example according to the first embodiment will be described.

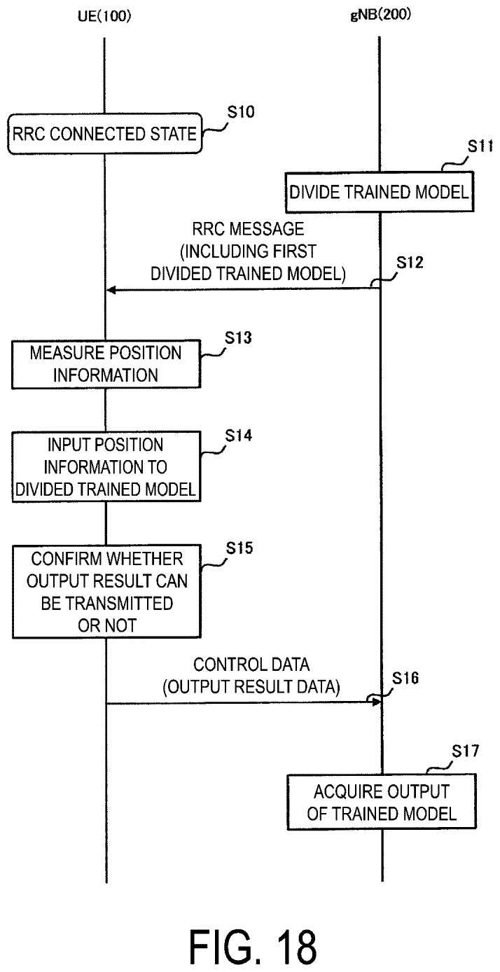

FIG. 18 is a diagram illustrating an operation example according to the first embodiment.

As illustrated in FIG. 18, in step S10, the UE 100 is in an RRC connected state.

In step S11, the gNB 200 divides a trained model into a first divided trained model and a second divided trained model. The first divided trained model includes at least an input layer of the trained model. On the other hand, the second divided trained model includes at least an output layer of the trained model. For example, the controller 230 of the gNB 200 divides the trained model.

In step S12, the gNB 200 transmits an RRC message (for example, a first message) to the UE 100, which includes the first divided trained model, execution interval information, and a threshold value. In this manner, since the gNB 200 does not transmit all the trained models to the UE 100, a load on the UE 100 can be reduced.

First, in the case of the trained model illustrated in FIG. 16, the first divided trained model includes the position information and the probabilities v11, v12, . . . for y1 and y2. In the case of the trained model illustrated in FIG. 17, the first divided trained model includes the position information and the probabilities w11, w12, w13, . . . for z1, z2, z3, . . . However, the first divided trained model does not include the content of the inference result data (for example, y1 represents “transmitting a handover request message”) from the viewpoint of ensuring confidentiality.

Second, the execution interval information represents an interval at which the first divided trained model is executed. The UE 100 executes processing on the first divided trained model at a timing of the interval in accordance with the execution interval.

Third, the threshold value is used by the UE 100 to determine whether to transmit the output result data to the gNB 200. The UE 100 transmits the output result data to the gNB 200 when the output result data is equal to or greater than the threshold value, and the UE 100 does not transmit the output result data to the gNB 200 when the output result data is less than the threshold value.

For example, the transmitter 210 of the gNB 200 transmits the RRC message. The UE 100 receives the RRC message. For example, the receiver 110 of the UE 100 receives the RRC message.

In step S13, the UE 100 measures its own position information. For example, the controller 130 of the UE 100 may acquire the position information using the GNSS reception device 150. Alternatively, the controller 130 of the UE 100 may receive PRS from the gNB 200, transmit measurement results for the PRS (for example, a received signal strength, a time difference from a plurality of cells, and the like) to a network (for example, a location management function (LMF)), and acquire position information from the network.

In step S14, the UE 100 inputs the position information to the first divided trained model at a timing indicated by the execution interval in accordance with the execution interval, and obtains output result data. For example, the controller 130 of the UE 100 acquires, from the first divided trained model, the probability for the position information (e.g., the probability v11 of y1 (transmitting a handover request message) for the position information x1 and the probability v12 of y2 (not transmitting a handover request message) for the position information x1) as output result data.

In step S15, whether to transmit the output result data is determined based on a threshold value (step S12). For example, the controller 130 of the UE 100 determines to transmit the output result data when the output result data (that is, the probability of obtaining inference result data) is equal to or greater than the predetermined value, and determines not to transmit the output result data when the output result data is less than the predetermined value. In the following description, it is assumed that the UE 100 determines to transmit the output result data.

In step S16, the UE 100 transmits control data (for example, a second message) including the output result data to the gNB 200. For example, the transmitter 120 of the UE 100 transmits the control data to the gNB 200. The gNB 200 receives the control data. For example, the receiver 220 of the gNB 200 receives the control data.

In step S17, the gNB 200 obtains inference result data from the output result data using the second divided trained model. For example, the gNB 200 performs the following processing.

That is, when the trained model is the model illustrated in FIG. 16, the gNB 200 infers whether to transmit a handover request message from the output result data. The gNB 200 transmits the handover request message to a target cell or does not transmit the handover request message to the target cell in accordance with the inference result.

When the trained model is the model illustrated in FIG. 17, the gNB 200 infers a handover parameter corresponding to the position information from the output result data, and transmits the handover parameter. When the gNB 200 obtains inference result data indicating that the handover request message is transmitted, in combination with the model illustrated in FIG. 16, the gNB 200 may transmit the handover parameter corresponding to the position information to the UE 100.

For example, the controller 230 of the gNB 200 acquires the inference result data from the output result data using the second divided trained model. Then, the backhaul communicator 250 of the gNB 200 may transmit a handover request message to another gNB in accordance with the inference result data, or the transmitter 210 in the gNB 200 may transmit a handover parameter in accordance with the inference result data.

Note that the handover parameter may be, for example, at least one of the following.

First, the handover parameter may be a changed value of a timer used when the execution of a handover procedure is started. The timer may be a T312 that is started when the UE 100 transmits a measurement report (or satisfies an event condition). In the UE 100 (or the network), changing the timer can delay or advance the start timing of the handover procedure compared to a case where the timer is not changed.

Second, the handover parameter may be an offset value for a signal strength of a neighboring cell. In response to obtaining the offset value from the trained model, the UE 100 adds the offset value to the signal strength for the neighboring cell and includes and transmits the added value in a measurement result (MeasurementResult).

Third, the handover parameter may be a parameter related to neighboring cell adjustment. Specifically, the parameter may be a cell ID of a cell that is not selected as a candidate cell which is a handover destination. The UE 100 may obtain measurement results for cells other than the cell ID without selecting the cell ID as a handover destination candidate.

Another Example 1 of Division of Trained Model According to First Embodiment In the first embodiment, the single-layer model has been described as the trained model, but the trained model used in the first embodiment is not limited to the single-layer model. For example, in the first embodiment, a trained model including a hidden layer (or an intermediate layer) may be used.

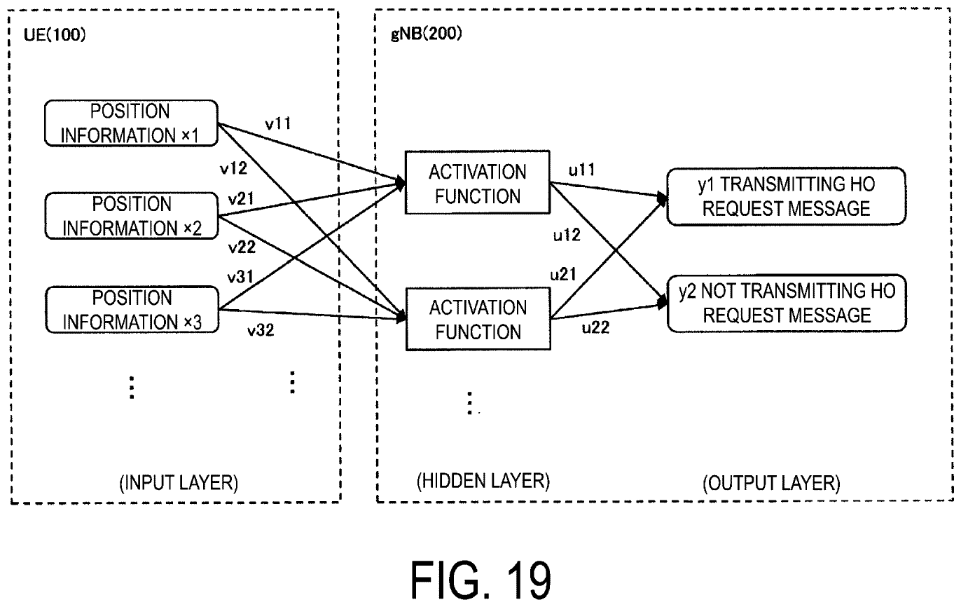

FIG. 19 is a diagram illustrating another example of division of the trained model according to the first embodiment.

FIG. 19 illustrates an example of a case where the gNB 200 includes a hidden layer.

As illustrated in FIG. 19, each node of the hidden layer includes a common activation function. As the activation function, for example, a known activation function such as a sigmoid function (y=1/(1+e^{-x})), a hyperbolic tangent function (y=(e^{x}−e^{-x})/(e^{x}+e^{-x})), or a rectified linear unit (ReLU) function (y=max(0,x)) may be used. For example, x to be input to each function is x=x1v11+x2v21+x3v31+ . . . in the case of an activation function in the uppermost stage of the hidden layer, and x is x=x1v12+x2v22+x3v32+ . . . in the case of an activation functions in the next stage. The activation function makes it possible to obtain two outputs, “transmitting a handover request message” and “not transmitting a handover request message”, for example, even when a large number of inputs are present.

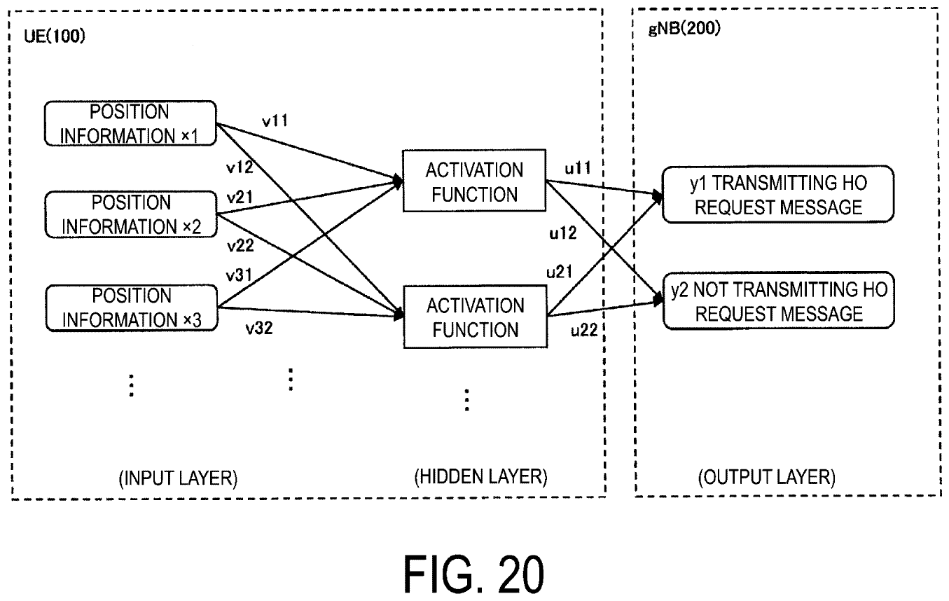

FIG. 20 is a diagram illustrating another example of division of the trained model according to the first embodiment. FIG. 20 illustrates an example of a case where the UE 100 includes a hidden layer.

As illustrated in FIG. 20, each node included in the hidden layer includes a common activation function, similarly to FIG. 19. The activation function may be a known activation function. When the UE 100 includes a hidden layer, the gNB 200 transmits information related to an input layer and information related to the hidden layer in the trained model to the UE 100. For example, the gNB 200 transmits, to the UE 100, pieces of position information x1, x2, x3, . . . , a probability v11 for an activation function in the uppermost stage, a probability v12 for an activation function in the next stage, . . . , as information related to the input layer. For example, the gNB 200 transmits, to the UE 100, an activation function included in the nodes of the hidden layer and probabilities u11, u12, u21, . . . for an output layer from the nodes, as the information related to the hidden layer. The gNB 200 may include and transmit, as a divided trained model, the information related to the input layer and the information related to the hidden layer to the UE 100 in an RRC message (step S12 in FIG. 18).

In FIG. 20, an example has been described in which the gNB 200 transmits the entire hidden layer to the UE 100, but this is not limiting. For example, the gNB 200 may transmit a part of the hidden layer to the UE 100. Although FIG. 20 illustrates an example in which the number of hidden layers is one, a plurality of hidden layers (when hidden layers are provided in multiple stages in the horizontal direction in FIG. 20) may be included as hidden layers. For example, when there exist four hidden layers, two layers close to the input layer may be provided in the UE 100, and two layers close to the output layer may be provided in the gNB 200. In this case, the gNB 200 transmits, to the UE 100, pieces of position information x1, x2, x3, . . . , a probability v11 for an activation function in the uppermost stage, a probability v12 for an activation function in the next stage, . . . , as information related to the input layer. For example, the gNB 200 transmits, to the UE 100, activation functions included in nodes of two layers close to the input layers, probabilities for nodes of the second layer from the nodes of the two layers, and probabilities for nodes of the third layer from the nodes of the second layer, as information related to the hidden layer. The gNB 200 may include and transmit, as a divided trained model, the information related to the input layer and the information related to the hidden layer to the UE 100 in an RRC message (step S12 in FIG. 18). In this manner, when the hidden layer includes a plurality of layers, the gNB 200 may transmit a part of the hidden layer to UE 100.

### Another Operation Example According to First Embodiment

In the first embodiment, an example (step S11) has been described in which the gNB 200 transmits an RRC message including a trained model and execution interval information. For example, gNB 200 may include and transmit the trained model and the execution interval information to UE 100 in a U-plane message.

### Other Embodiments

In the first embodiment described above, the supervised learning has mainly been described. However, the present disclosure is not limited thereto. For example, unsupervised learning or reinforcement learning may be applied to the first embodiment.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed. In each flow, the order of the steps may be changed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node. That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the apparatus according to the above-described embodiment may be implemented in circuitry or processing circuitry including general purpose processors and special purpose processors that are programmed to achieve the described functions, integrated circuits, application specific integrated circuits (ASICs), a central processing unit (CPU), conventional circuits, and/or combinations thereof. The processor may include transistors and other circuits and may be considered a circuitry or a processing circuitry. The processor may be a programmed processor that executes a program stored in the memory. In the present disclosure, a circuitry, a unit, and a means are hardware programmed to achieve, or hardware executing the described functions. The hardware may be any hardware disclosed herein or any hardware programmed to achieve or known to perform the described functions. When the hardware is a processor that is considered to be a type of circuitry, the circuitry, means, or unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTARY NOTES

### Supplementary Note 1

A communication control method in a mobile communication system, the communication control method including:
dividing, by a network node, a trained AI/ML model into a first divided trained model and a second divided trained model;
transmitting, by the network node, a first message including the first divided trained model to user equipment;
acquiring, by the user equipment, position information indicating a position of the user equipment;
acquiring, by the user equipment, output result data from the position information by using the first divided trained model;
transmitting, by the user equipment, a second message including the output result data to the network node; and
inferring, by the network node, whether to execute a mobility operation from the output result data by using the second divided trained model,
in which the mobility operation includes at least transmitting a handover request message to another network node by the network node.

### Supplementary Note 2

The communication control method according to Supplementary Note 1, in which the first message includes a threshold value,
the transmitting of the second message includes transmitting, by the user equipment, the second message when the output result data is equal to or greater than the threshold value, and not transmitting, by the user equipment, the second message when the output result data is less than the threshold value.

### Supplementary Note 3

The communication control method according to Supplementary Note 1 or 2, in which
the first divided trained model includes at least an input layer of the trained AI/ML model, and the second divided trained model includes at least an output layer of the trained AI/ML model.

### Supplementary Note 4

The communication control method according to any one of Supplementary Notes 1 to 3, in which the mobility operation includes setting of a parameter used in a handover.

### Supplementary Note 5

The communication control method according to any one of Supplementary Notes 1 to 3, in which
the first message includes execution interval information indicating an execution interval of the first divided trained model, and
the acquiring of the output result data includes acquiring, by the user equipment, the output result data from the position information by using the first divided trained model in accordance with the execution interval.

### Supplementary Note 6

A network node in a mobile communication system, the network node including:
a controller configured to divide a trained AI/ML model into a first divided trained model and a second divided trained model;
a transmitter configured to transmit a first message including the first divided trained model to a user equipment; and
a receiver configured to receive, from the user equipment, a second message including output result data acquired from position information by the user equipment by using the first divided trained model, in which
the controller infers whether to execute a mobility operation from the output result data by using the second divided trained model, and
the mobility operation includes at least transmitting a handover request message to another network node by the network node.

### Supplementary Note 7

A user equipment in a mobile communication system, the user equipment including:
a receiver configured to receive a first message including a first divided trained model from a network node, the first divided trained model being obtained by dividing a trained AI/ML model into the first divided trained model and a second divided trained model;
a controller configured to acquire position information indicating a position of the user equipment and acquire output result data from the position information by using the first divided trained model; and
a transmitter configured to transmit a second message including the output result data to the network node, in which
the network node infers whether to execute a mobility operation from the output result data by using the second divided trained model, and
the mobility operation includes at least transmitting a handover request message to another network node by the network node.

### REFERENCE SIGNS

1: Mobile communication system
20: 5GC (CN)
100: UE
110: Receiver
120: Transmitter
130: Controller
200: gNB
210: Transmitter
220: Receiver
230: Controller

1. A communication control method in a mobile communication system, the communication control method comprising:
dividing, by a network node, a trained artificial intelligence (AI)/machine learning (ML) model into a first divided trained model and a second divided trained model;
transmitting, by the network node, a first message comprising the first divided trained model to a user equipment;
acquiring, by the user equipment, position information indicating a position of the user equipment;
acquiring, by the user equipment, output result data from the position information by using the first divided trained model;
transmitting, by the user equipment, a second message comprising the output result data to the network node; and
inferring, by the network node, whether to execute a mobility operation from the output result data by using the second divided trained model,
wherein the mobility operation comprises at least transmitting a handover request message to another network node by the network node.

2. The communication control method according to claim 1, wherein
the first message comprises a threshold value, and
the transmitting of the second message comprises transmitting, by the user equipment, the second message when the output result data is equal to or greater than the threshold value, and not transmitting, by the user equipment, the second message when the output result data is less than the threshold value.

3. The communication control method according to claim 1, wherein
the first divided trained model comprises at least an input layer of the trained AI/ML model, and
the second divided trained model comprises at least an output layer of the trained AI/ML model.

4. The communication control method according to claim 1, wherein the mobility operation comprises setting of a parameter used in a handover.

5. The communication control method according to claim 1, wherein
the first message comprises execution interval information indicating an execution interval of the first divided trained model, and
the acquiring of the output result data comprises acquiring, by the user equipment, the output result data from the position information by using the first divided trained model in accordance with the execution interval.

6. A network node in a mobile communication system, the network node comprising:
a controller configured to divide a trained AI/ML model into a first divided trained model and a second divided trained model;
a transmitter configured to transmit a first message comprising the first divided trained model to a user equipment; and
a receiver configured to receive, from the user equipment, a second message comprising output result data acquired from position information by the user equipment by using the first divided trained model, wherein
the controller infers whether to execute a mobility operation from the output result data by using the second divided trained model, and
the mobility operation comprises at least transmitting a handover request message to another network node by the network node.

7. A user equipment in a mobile communication system, the user equipment comprising:
a receiver configured to receive a first message comprising a first divided trained model from a network node, the first divided trained model being obtained by dividing a trained AI/ML model into the first divided trained model and a second divided trained model;
a controller configured to acquire position information indicating a position of the user equipment and acquire output result data from the position information by using the first divided trained model; and
a transmitter configured to transmit a second message comprising the output result data to the network node, wherein
the network node infers whether to execute a mobility operation from the output result data by using the second divided trained model, and
the mobility operation comprises at least transmitting a handover request message to another network node by the network node.
